(19) United States
(12) Patent Application Publication
(10) Pub. No.: US 2006/0067470 A1
(43) Pub. Date: Mar. 30, 2006

(54) Monitoring signal-to-noise ratio in x-ray diffraction data

(76) Inventors: Bi-Cheng Wang, Athens, GA (US); Zheng-Qing Fu, Watkinsville, GA (US); John P Rose, Winterville, GA (US)

Correspondence Address: GREENLEE WINNER AND SULLIVAN P C, 4875 PEARL EAST CIRCLE, SUITE 200, BOULDER, CO, 80301, US

(21) Appl. No.: 10/520,777

(22) PCT Filed: Jul. 14, 2003
(86) PCT No.: PCT/US03/21988

§ 371 Date: Jun. 27, 2005

(30) Foreign Application Priority Data
Jul. 13, 2002 (US) 60319396

(51) Int. Cl. G01N 23/207

(52) U.S. Cl. 378/73

(57) ABSTRACT

The present invention relates to methods of diffractometrically determining the structures of materials by characterizing their electron density distributions. More particularly, the present invention relates to methods of collecting, processing and interpreting X-ray diffraction data, which allow real time evaluation of the signal-to-noise ratio in crystal diffraction experiments. The present methods related to the derivation of statistical indices for monitoring and evaluating signal-to-noise ratios in diffraction experiments. In addition, the present invention provides methods of determining the electron density distributions of crystals using anomalous scattering signals corrected for noise. Further, the present invention provides methods of increasing the signal-to-noise ratios in X-ray diffraction data.

### STATEMENT REGARDING FEDERALLY SPONSORED RESEARCH OR DEVELOPMENT

The work was funded through a grant by the United States government under NIH grant P50GM06240703. The United States government has certain rights in this invention.

### BACKGROUND OF INVENTION

Electromagnetic radiation is used in diffractometric methods to resolve the structure of crystalline materials having interatomic distances comparable to the wavelength of the incident radiation. For example, in X-ray crystallography techniques a crystal is mounted between an X-ray source and an X-ray detector and a narrow monochromatic source beam of X-rays having wavelengths around 1 Å is directed onto the crystal. Atoms in various planes of the crystal diffract the source beam, thereby, generating a plurality of discrete refracted X-ray beams, which are detected and characterized with respect to their spatial orientation and intensity distribution. The directions and intensities of the diffracted X-ray beams, are monitored both as a function of time and the rotational orientation of the crystal. Diffraction patterns comprising a series of individually detected diffracted X-ray beams, referred to as reflections, are collected and analyzed to provide information related to the structure of the irradiated crystal. Indeed, the observed diffraction pattern is uniquely determined by the structure of the irradiated crystal. Essential to the collection of useful X-ray diffraction data is the use of high quality crystalline samples characterized by a single phase having a well ordered crystalline structure.

In recent years, X-ray crystallography has proven a powerful technique for determining the structures of a wide variety of complex materials including crystals of macromolecules, such as purified proteins, peptides, protein-protein complexes, carbohydrates, oligonucleotides and nucleic acid—protein complexes. Techniques for collecting X-ray diffraction data are described in “Principles of protein X-ray crystallography” by Jan Drenth, Springer-Verlag, 1994 and “The Basics of Crystallography and Diffraction” by Christopher Hammond, Oxford University Press, 2001.

The intensities (I) of reflections of the diffracted X-rays and corresponding positions are the primary source of crystallographic data used in the determination of crystal structure. A crystal can be characterized as a three-dimensional translational structure of the crystalline unit cells. In addition to its translational symmetry, a crystalline structure can be characterized by symmetries within its unit cell. In the case of a protein molecule, there are 65 known ways to combine the symmetry operations in a crystal, called 65 space symmetry groups. Each reflection off a crystal can be characterized by three indices, h, k, and l, which describe the reciprocal lattice use in interpreting diffraction data. One can measure the intensity I(h,k,l) for each reflection.

To resolve a crystalline structure, an electronic density distribution of the crystal must be obtained from the measured reflection data. ρ(u,v,w), the electron density distribution, is a three-dimensional function of the coordinate system tied to the axes of the unit cell of the crystal. X-ray diffraction data can be used to calculate a structure factor, which in itself is insufficient to calculate the electron density. Specifically, the phase of each reflection, commonly calculated in terms of phase angle, is required in addition to intensities and positions evident in the diffraction pattern.

A number of diffraction pattern analysis techniques exist for extracting phase information from the measured intensities and positions of X-ray beams scattered by an irradiated crystal. Diffraction patterns corresponding to crystals comprising small molecules (molecular mass<500 Da) exhibit high redundancy, which allows for structure determination using direct methods. Specifically, high redundancy allows phase information to be obtained directly by evaluating relationships between observed structure factors and the desired phases. Direct methods use probability relationships to assign phases to a small set of data and determine modified electron density distributions based in this subset which accurately represents the structure under analysis. As direct methods, these methods do not depend on the presence of heavy atoms or atoms having other special optical properties.

For larger molecules (molecular mass>500 Da), such as proteins, peptides and oligonucleotides, determining estimates of the phases of each reflection via direct methods is infeasible. As a result of this limitation, new analytical methods have evolved over the last several decades which provide means of estimating the phase angles of reflections generated by irradiating crystals comprising large molecules. The most common methods of resolving the crystal structures of these larger molecular mass compounds are multiple isomorphous replacement (MIR) methods, molecular replacement (MR) methods and anomalous scattering (AS) techniques. Although these methods provide a means of solving the phase problem, the phase estimates provided are often limited to an incomplete set of reflections. Therefore, subsequent improvement, refinement and probability weighting of the phase estimates are often necessary to arrive at electron density distributions, which can be used to interpret a sample's structure.

In multiple isomorphous replacement, the diffraction pattern of a native crystalline sample is collected and compared to the diffraction pattern of a derivative of the crystal, typically a heavy atom derivative. Specifically, heavy atoms, such as ions or complexes of Hg, Pt, Au etc., are incorporated into a crystal in chemically specific and reproducible orientations. Furthermore, the derivative crystals must be isomorphic with the native crystal, such that incorporation of the additional atoms does not significantly disrupt the lattice structure of the crystal sample. Differences in the diffraction patterns corresponding to native crystal and derivative crystal are used to calculate estimates of the phases of the observed reflections. Therefore, the perturbation caused by the introduction of heavy atoms into the derived structure provides a means of estimating phase. The changes in diffraction patterns of native and derivative crystals must be clearly detectable and large enough to obtain good phase estimates. Therefore, the ability to arrive at accurate electron density distributions using isomorphous replacement methods is highly dependent on collecting X-ray diffraction data having signal-to-noise ratios sufficiently large to allow native and derivative diffraction patterns to be quantitatively compared.

In molecular replacement methods calculated phases of a reference protein are used as initial estimates for the phases of another target protein, preferably a structurally related protein. Specifically, the reference protein is used as a phasing model to arrive at a structure of the target protein. This technique is especially useful if the reference and target are structurally related, such as homologous proteins. Molecular replacement methods require X-ray diffraction data exhibiting high signal-to-noise ratios to achieve accurate electron density distributions and structures.

Anomalous scattered techniques take advantage of the capacity of heavy atoms, such as S, P, Cl or metals, to absorbed X-ray radiation. Specifically, absorption of X-rays by a heavy atom followed by re-emission of light with an altered phase results in Bragg reflections related by inversion through the origin, referred to as Friedel pairs, which are not equal in intensity. Measurements of the differences in intensities of members of Friedel pairs allows for estimation of the phase of these reflections. Typically, the intensity differences between members of a Friedel pair are very small, often less than 5%. Therefore, the ability to arrive at accurate structures using anomalous dispersion techniques is highly dependent on collecting X-ray diffraction data having a signal-to-noise ratio sufficiently large to allow the difference in intensity between members of Friedel pairs to be accurately characterized. In addition, measurements of the intensities of members of a Friedel pair must be made under very similar experimental conditions to ensure that the observed difference in intensity arises from the phase change imparted upon X-ray absorption followed by re-emission rather than by changes in the crystal structure, physical environment surrounding the crystal or changes in the quality of the X-ray diffraction system. Finally, the accuracy of structures determined using anomalous dispersion techniques can be greatly increased by collecting and analyzing diffractions patterns corresponding to a plurality of different incident light wavelengths using multiple wavelength anomalous diffraction (MAD) methods.

Currently, high throughput methods for determining the structure of large molecules, such as proteins, peptides and oligonucleotides, are greatly needed to provide structural information which is complementary to the growing body of functional data related to the biological activity these compounds. Indeed, high throughput methods of macromolecule structure determination would assist greatly in the discovery and development of small molecule pharmaceuticals capable of interacting with individual proteins, protein aggregates, carbohydrates, nucleic acids or other macromolecules important in regulating normal cell functioning and disease pathways. In particular, single-wavelength anomalous diffraction (SAD) has a great deal of promise for high throughput structure determination of larger molecules. First, this technique is more economic and more efficient than other methods, since the necessity of preparing selenium-labeled proteins or heavy-atom derivatives is eliminated. Second, the technique does not require expensive tunable synchrotron X-ray radiation sources. Rather, single-wavelength anomalous scattering is compatible with home X-ray sources, such as Cu-K_{α} sources, which are readily available and inexpensive. Further, these methods do not require time consuming multi-wavelength measurements. Single-wavelength anomalous scattering, therefore, has the potential to provide a significant tool in large-scale macromolecular structural analysis associated with structural genomics.

Although X-ray diffractometric techniques are capable of determining the crystal structures of many of compounds, the full potential of the application of this techniques to biomolecules is currently not realized due to substantially limitations related to the signal-to-noise ratios of crystallographic data collected using conventional diffractometric methods. Indeed, conventional techniques of collecting and analyzing crystallographic data are inefficient and often lack the signal-to-noise ratio needed for the accurate determination of electron density distributions of large compounds. First, conventional X-ray diffractometric techniques for determining structures of large molecules lack reliable and quantitative methods of evaluating signal-to-noise ratios during and after data collection. Therefore, it is common practice to completely discard substantial amount of data upon realization that the signal-to-noise ratios are too low to generate reliable electron density distributions. This limitation is particularly relevant to anomalous scattering techniques wherein the anomalous differences in intensity are very small and, thus high signal-to-noise ratio is essential. Second, conventional analysis methods of crystallographic data utilize average intensities of members of Friedel pairs, which may introduce artifacts in the structure analysis and electron density determination. Furthermore, averaging the intensity of members of a Friedel pair discards valuable information related to sources of noise in the experiment. Finally, conventional X-ray diffractometric techniques lack a sensitive and effective means of monitoring and assessing important experimental parameters, such as the quality of an irradiated crystal sample or X-ray diffraction system, during data collection.

It will be appreciated from the foregoing that there is currently a need in the art for improved methods of collecting, analyzing and interpreting X-ray diffraction data which provide higher signal-to-noise ratios. In addition, methods of quantifying and evaluating signal-to-noise ratios of crystallographic data in real time during data collection are needed. Furthermore, methods of signal averaging and statistical methods of analyzing diffraction data are needed to improve the usefulness of the X-ray diffraction data generated by diffractometric methods.

### SUMMARY OF THE INVENTION

The present invention relates to methods of diffractometrically determining the structures of materials by characterizing their electron density distributions. More particularly, the present invention relates to methods of collecting, processing and interpreting X-ray diffraction data, which allow real time evaluation of the signal-to-noise ratio in crystal diffraction experiments. The present methods relate to the derivation of statistical indices for monitoring and evaluating signal-to-noise ratios in diffraction experiments. In addition, the present invention provides methods of assessing experimental uncertainty in X-ray diffraction data and in crystal structures derived from experimental data, which are more sensitive than conventional methods. The improved signal-to-noise ratios and error analysis provided by the present invention result in more reliable and reproducible electron density distributions, which are useful for characterizing the structural and functional properties of crystal samples. The present methods are especially useful for determining electron density distributions and structures for crystals comprised of large molecules, including but not limited to proteins, peptides, protein-protein complexes; protein-lipid complexes; olignucleotides; carbohydrates; lipid-carbohydrate complexes and nucleic acid-protein complexes.

In one aspect, the present invention provides methods of monitoring and statistically evaluating noise levels observed in X-ray diffraction data. In one embodiment, the intensities of diffracted X-ray beams corresponding to symmetry related reflections are measured and compared to each other to provide a real time measurement of random and non-random noise. The methods of the present invention allow for characterization of an average noise level corresponding to an entire X-ray diffraction data set. Alternatively, the methods of the present invention provide a means of characterizing temporal behavior of random and non-random noise during collection of X-ray diffraction data. Preferred methods of the present invention provide a means of evaluating noise levels corresponding to very short data collection time intervals. In some applications, the present invention provides a means of analyzing signal-to-noise levels corresponding to data collection time intervals less than 10 minutes and preferably less than 2 minutes for some applications. Characterization of noise levels corresponding to short time intervals is beneficial because it allows trends in noise as a function of time to be quantitatively evaluated. Noise levels obtained by the methods of the present invention may be used to provide real time measurements of signal-to-noise ratios observed during an X-ray diffraction experiment. In addition, noise levels measured by the methods of the present invention may be used to correct diffraction signals, particularly anomalous diffraction signals, for the presence of random and non-random noise. Noise levels measured by the methods of the present invention also provide information valuable for assessing the quality of a given crystal sample and degradation rates of a crystal due to exposure to X-rays, changes in temperature or other environmental conditions. Further, noise levels measured by the methods of the present invention also provide information valuable for assessing the performance of an X-ray diffraction system including methods of evaluating the stability of an X-ray detector, the uniformity of an X-ray source and/or the stability of a crustal alignment system.

In another embodiment of the invention, the present invention includes methods of determining crystal structures using X-ray diffraction data corrected for non-random and random noise. The goal of this aspect of the present invention is to provide methods of increasing signal-to-noise ratios such that more reliable and reproducible electron density distributions are determined. Methods of the present invention using X-ray diffraction data corrected for non-random and random noise levels are beneficial because more accurate electron density distributions may be determined with less signal averaging and redundancy than in conventional diffractometric methods. A preferred application of this aspect of present invention relates to methods of determining crystal structures using anomalous scattering signals corrected for non-random and random noise. In an exemplary embodiment, the present method comprises collecting X-ray diffraction data comprising intensities corresponding to a centric reflection pair and an acentric reflection pair. The exemplary method provides for subtracting the intensities of the centric reflection pair to obtain a first intensity difference and subtracting the intensities of the acentric reflection pair to obtain a second intensity difference. In a preferred exemplary embodiment, the first intensity difference is related to the level of noise in the X-ray diffraction data and the second intensity difference is related to the anomalous signal plus the level of noise in the X-ray diffraction data The methods of the present invention further provides for calculating an anomalous scattering signal corrected for noise using the first intensity difference and the second intensity difference and using the anomalous scattering signal corrected for the noise to determine an electron density distribution for the crystal. In addition, the present methods may further comprising the step of using the anomalous scattering signal corrected for noise to determine an anomalous scattering power of the crystal. As follows from the description of the method, it now becomes possible to monitor the anomalous scattering signal data separated from the noise data in real time as the diffractometric measurements are being taken.

In an alternative embodiment, the present method comprises collecting X-ray diffraction data comprising intensities corresponding to a plurality of centric reflection pairs and a plurality of acentric reflection pairs. An average first intensity difference may be determined by subtracting the intensities of the plurality of centric reflection pairs and an average second intensity difference may be determined by subtracting the intensities of the plurality of acentric reflection pairs. In a preferred exemplary embodiment, the average first intensity difference relates to the noise level in the X-ray diffraction data and the average second intensity difference relates to the anomalous signal plus noise level in the X-ray diffraction data. An anomalous scattering signal corrected for noise may be calculated using the average first and second intensity differences, which may be use to determine the electron density distribution for the crystal. The exemplary method may further include the steps of calculating a first weighted average of the first intensity difference by dividing the average first intensity difference by the standard deviation of the intensities and calculating a second weighted average of the second intensity difference by dividing the average second intensity difference by the standard deviation of the intensities. In addition, the exemplary methods may further comprising the step of calculating a ratio of the first weighted average of the first intensity difference and the second weighted average of the second intensity difference. In an alternative embodiment, weight averages of first and second intensity differences may be calculated using the square of the standard deviation of the measured intensities.

In another aspect, the present invention provides methods of directly evaluating signal-to-noise ratio observed in an X-ray diffraction experiment. More particularly, the methods of the present invention provide a statistical index for evaluating average signal-to-noise ratio for a selected data collection period. Alternatively, the statistical index of the present invention may provide a means of evaluating trends in the signal-to-noise ratio in real time. In an exemplary embodiment, intensities of symmetry related reflection pairs are measured and statistically analyzed to provide a measurement of signal-to-noise ratio. A preferred application of this aspect of present invention relates to methods of evaluating the ratio of anomalous scattering signals to measured noise levels. An exemplary method of this aspect of the present invention comprises the steps of collecting X-ray diffraction data corresponding to the intensities of centric and acentric reflection pairs, using intensities corresponding to centric reflection pairs to determine noise levels, using intensities corresponding to acentric reflections to determine anomalous scattering signals and statistically evaluating the determined noise levels and anomalous scattering signals to provide a measure of signal-to-noise ratio.

The present methods of evaluating signal-to-noise ratios during collection of diffraction data are beneficial because they allow important experimental parameters to be assessed in real time during data collection. First, the present methods of evaluating signal-to-noise ratios in real time provide a means of determining how much signal averaging is necessary to provide X-ray diffraction data capable of generating reliable and reproducible electron density distributions. The ability to quantitatively assess the amount of signal averaging and redundancy necessary to achieve accurate electron density distributions is beneficial because it maximizes the efficiency f X-ray diffraction data collection methods and supports applications of high throughput structure determinations. In addition, the methods of the present invention are able to identify experimental conditions wherein further signal averaging and redundancy does not improve signal-to-noise ratios or actually decreases signal-to-noise ratios. Second, the present methods of evaluating signal-to-noise ratios in real time provide a means of assessing the quality of an irradiated crystal sample. In this context, the quality of an irradiated crystal sample refers to the uniformity of the crystal structure, uniformity of the physical environment surrounding the crystal, the extent of crystallinity and/or polycrystallinity of the sample, structural integrity and mosaicity. Observed trends in signal-to-noise ratio may be related to changes in crystal quality and, therefore, may provide a means of assessing when a change in crystal sample is necessary. In an exemplary embodiment, for example, a new crystal sample is deemed necessary when the observed signal-to-noise ratios fall below a specified threshold value, such as a value of signal-to-noise of 1.67. The value of this threshold may depend on a number of variable include the structure of the crystal, the anomalous scattering power of the crystal and the X-ray diffraction system employed. Third, the present methods of evaluating signal-to-noise ratios in real time provide a means of assessing other experimental parameters important to collecting X-ray diffraction data having high signal-to-noise ratios. For example, decreases in observed signal-to-noise ratio may be used to identify instabilities in the X-ray source, crystal alignment system or X-ray detector.

The present invention also provide statistical methods for analyzing a plurality of discrete X-ray diffraction data sets, which improve observed signal-to-noise ratios. In an exemplary method, diffraction patterns are collected in discrete diffraction data sets corresponding to intensity distributions and positions of reflections acquired over different time intervals and/or for different crystal samples. The signal-to-noise ratios of individual diffraction data sets are evaluated using the methods of the present invention. Next, two or more discrete data sets are merged and the signal-to-noise ratios of the combined data sets are determined and compared to the signal-to-noise ratio of the discrete diffraction data sets. In this manner, the signal-to-noise ratio is calculated for all possible combinations of the discrete diffraction data sets. Combinations of data sets are identified wherein the merger of two or more data sets results in an improvement in the observed signal-to-noise ratio. Improvements in signal-to-noise ratio for a merged set may be provided when sources of noise in the data have opposing effects and, hence, cancel each other out. This aspect of the present invention enables the maximum amount of useful information in a diffraction data set or plurality of data sets to be extracted and utilized in determination of electron density distributions. This aspect of the present invention is applicable to any X-ray diffraction technique where high signal-to-noise ratio is desirable, particularly single wavelength anomalous scattering techniques, multiple wavelength anomalous scattering techniques, multiple isomorphous replacement methods and molecular replacement methods.

The concept of separating an overall data set into its data subsets and evaluating the statistics of these data subsets individually in order to identify and separate noise and signal levels, as described and claimed therein, opens up the possibility of monitoring the signal and noise levels in any types of data sets containing two or more data subsets in an overall experimental data set. For example, if within the overall data set there are subsets of data of a theoretically equal value, then the data within this type of data set can be used to produce a true measurement of noise level in the data, since in the real life experiment the theoretical value is never achieved due to experimental and instrumental errors typed of data which are theoretically different can then be used to measure the signal (with noise) level. By comparing the overall magnitudes of these two types of data, one can then monitor the signal-to-noise ratio and determine the usefulness of the data. If there is a signal in the data, but the signal-to-noise ratio is not high enough, one may want to collect additional data to see if the signal-to-noise ratio can be increased when the redundancy in the data set is increased. The ability to directly monitor and statistically evaluate the quality of experimental data during collection is a significant improvement in determining if an experiment is complete or if such an experiment can or cannot produce a successful result. The present invention provides a way to carry out such an evaluation for most types of experimental data. Other types of experiments which can be benefitted by the methods of the present invention include, but are not limited to, the neutron and electron diffraction experiments from crystalline materials and any experiments that have data with the above-described characteristics.

In addition to anomalous scattering measurements, the methods of the present invention are applicable to any X-ray diffraction method. The benefits of the increased signal-to-noise ratio provided by the present invention, however, are greatest for diffraction methods which rely on relatively small signals or changes in signals to determine crystal structure, such as single-wavelength anomalous scattering techniques, multiple wavelength anomalous scattering techniques, multiple isomorphous replacement methods, and molecular replacement methods. In the context of the application of the present methods in multiple isomorphous replacement techniques, a better comparison of diffraction data corresponding to native and derivative crystals may be performed using diffraction data having high signal-to-noise ratios.

In another aspect, the present invention comprises methods of collecting X-ray diffraction data. In an exemplary embodiment, the method comprising the steps of: (1) measuring intensities corresponding to a plurality of centric reflection pairs and a plurality of acentric reflection pairs; (2) calculating anomalous scattering signal-to-noise ratios for the intensities corresponding to a plurality of data collection time intervals and (3) stopping the collection of the intensities when the anomalous scattering signal-to-noise is below an anomalous scattering signal-to-noise threshold. In a preferred embodiment, the anomalous scattering signal-to-noise threshold is 1.67.

In another aspect, the present invention comprises methods of monitoring changes in the signal-to-noise ratio of X-ray diffraction data. An exemplary method comprising the steps of: (1) measuring a first set of intensities corresponding to a plurality of centric reflection pairs and a plurality of acentric reflection pairs and calculating an first anomalous scattering signal-to-noise ratio for the first set of intensities; (2) measuring a second set of intensities corresponding to a plurality of centric reflection pairs and a plurality of acentric reflection pairs and calculating a second anomalous scattering signal to noise ratio for the second set of intensities and (3) comparing the first anomalous scattering signal-to-noise ratio to the second anomalous signal-to-noise ratio.

The invention is further illustrated by the following description, examples, drawings and exemplary claims.

### BRIEF DESCRIPTION OF DRAWINGS

FIGS. 1A-1D are the graphs representing the 60°, 120° and 180° crystal orientations of Zn-free insulin data sets, respectively.

FIG. 2 is a representation of the electron density around Leu 11B of Zn-free insulin.

### DETAIL DESCRIPTION OF THE INVENTION

Hereinafter, the following definitions apply:

“Noise” and “noise level” are used synonymously and refer to the difference in the intensities of a pair of centric reflections and is mathematically represented by the equation:
noise=I₊^{c}−I₋^{c};
wherein I₊^{c} and I₋^{c} are centric reflections.

Noise may comprise random noise, non-random noise or a combination of random and non-random noise. Noise may originate from a wide variety of sources. In one aspect of the present invention, sources of noise include, but are not limited to, anisotropic crystal defects or disorder of a crystal sample, anisotropies in the physical environment of a crystal sample, variations in the intensity of the incident X-ray beam, variations in the sensitivity of a X-ray detector, and variations in the physical orientation of a crystal sample. Noise may change significantly with time, for example due to degradation of a crystal sample. Alternatively, noise may remain substantially constant over a selected diffraction data collection interval.

“Signal” refers to any detectable output which is distinguishable from noise. In certain applications of the present invention, signals comprise the intensities of one or more reflections, the intensity distribution of one or more reflections, differences of the intensities of two or more reflections or Bijvoet differences of acentric reflections. In one embodiment of the present invention, signals are used to evaluate the signal-to-noise ratio of a X-ray diffraction data set in real time and/or assess experimental parameters, such as the quality of a crystal sample.

“Physical environment of a crystal” refers the media surrounding a crystal sample. In the present invention, the physical environment of a crystal sample can be isotropic, anisotropic or have regions which are isotropic or anisotropic. In some applications, the physical environment surrounding a crystal sample comprises frozen or partially frozen mother liquor.

“Centric reflections” refer to a pair of diffracted X-ray beams related by symmetry, such as inversion through the origin or rotational symmetry, that are also symmetric mates. In theory, members of a centric reflection pair exhibit identical intensities. Therefore, centric reflections obey the Friedel relationship:
I₊^{c}I=I₋^{c},
wherein I₊^{c} and I₋^{c} are the intensities of centric reflections.

In experiments, however, members of a centric reflection pair often exhibit intensities which are not identical due to the existence of random and non-random noise. Therefore, centric reflection pairs of the present invention may include symmetry related reflection pairs that exhibit non-identical intensities due to the presence of noise. Centric reflections useful for practicing the methods of the present invention include, but are not limited to, pairs of diffracted beams related by inversion through the origin or rotationally related reflections, such as 2-, 3-, 4- and 6-fold symmetry reflections. In the present invention, differences in the intensities of members of a centric reelection pair provide a direct measurement of noise levels in an X-ray diffraction data set.

“Acentric reflections” refer to pair of diffracted beams related by inversion through origin that are not symmetric mates. Members of an acentric reflection pair exhibit different intensities due to the absorption and subsequent re-emission of diffracted X-rays of the reflection pair. Acentric reflection pairs do not obey the Friedel relationship and, therefore, I₊^{a}≈I₋^{a}; wherein I₊^{a} and I₋^{a} are the intensities of acentric reflections.

The differences in intensities of members of one or more acentric reflection pairs provide information related to the phases of reflections observed in an X-ray diffraction pattern.

“Anomalous scattering signal” refers to a portion of the difference in intensities of a pair of acentric reflections which arises from the absorption and subsequent re-emission of X-rays during the diffraction process. The present invention provides methods of determining anomalous scattering signals corrected for noise and methods of increasing the ratio of an anomalous scattering signal-to-noise.

“X-ray diffraction data” and “X-ray diffraction data set” are used synonymously and refers to a data set characterizing a plurality of discrete refracted X-ray beams. An X-ray diffraction data set may include measurements of the intensities, intensity distributions and positions of reflections, particularly centric and acentric reflection pairs. The quality of an X-ray diffraction data set refers to the ability to determine reliable and reproducible electron density distributions from the data set. High quality X-ray diffraction data typically are characterized by high signal-to-noise ratios.

“Friedel pair” is a pair of Bragg reflections related by inversion through the origin. When anomalous scattering can not be neglected, the result is the break down of Friedel's law, I(h, k, l)≈I(−h, −k, −l) and the pairs are more correctly called Bijvoet pairs.

“Bijvoet difference” refers to the difference in the measured intensities for members of a Bijvoet pair. Bijvoet difference may be expressed by the expression:
ΔI=|I₊|−|I₋|,
wherein ΔI is the Bijvoet difference, and I₊ and I₋ are the intensities of the Bijvoet pair.

“Intensity difference” refers to the difference in the intensities of the members of a symmetry related reflection pair. Intensity differences useful in the methods of the present invention include the difference in the intensities of a pair of centric reflections and the difference in the intensities of a pair of acentric reflections. Intensity differences of the present invention may be Bijvoet differences.

In the following description, numerous specific details of the devices, device components and methods of the present invention are set forth in order to provide a thorough explanation of the precise nature of the invention. It will be apparent, however, to those of skill in the art that the invention can be practiced without these specific details. Reference in the specification to “a preferred embodiment,” “a more preferred embodiment” or “an exemplary embodiment” means that a particular feature, structure, or characteristic set forth or described in connection with the embodiment is included in at least one embodiment of the invention. Reference to “preferred embodiment,” “a more preferred embodiment” or “an exemplary embodiment” in various places in the specification do not necessarily refer to the same embodiment.

The present invention relates to methods of collecting, processing and interpreting X-ray diffraction data, which allow real time evaluation of the signal and noise data separately in an experimental data set. More specifically, the methods relate to the derivation of a statistical index for monitoring the signal-to-noise ratio in the diffraction experiments, correcting anomalous scattering signals for noise and maximizing the signal-to-noise ratio in an X-ray diffraction data set.

In an exemplary embodiment, the present invention provides methods for extracting a weak anomalous scattering signal from a X-ray diffraction data set, which call for a separate, accurate measurement and evaluation of the signal and noise in the data set. Although the descriptions of the method provided herein focus primarily on single-wave anomalous scattering methods, the methods provided are also applicable to multiple-wavelength anomalous scattering methods, multiple isomorphous replacement methods and molecular replacement methods.

An exemplary method of determining an anomalous scattering signal corrected for noise involves statistically analyzing the intensities of centric and acentric reflections. Intensities of centric and acentric reflections pairs may be measured by any means available in the art. In a preferred embodiment, intensities of members of a given Friedel pair are measured under similar experimental conditions and as close in time as possible. Exemplary methods useable in the present invention include the use of defractometry, wherein members of a Friedel pair are measured sequentially (i.e. back-to-back). An advantage of defractometry methods is that measurements of the intensities of members of a Friedel pair are made very close in time. Alternatively, methods of the present invention include the use of area detectors, wherein a large number of reflections are measured at once and later analytically reduced. An advantage of the use of area detectors is that a large amount of data can be collected in a short time and, therefore, these methods maximize the amount of data which can be collected over the useful lifetime of a crystal sample.

The statistical average of the reflection intensity, Δ, is routinely used to evaluate the strength of the anomalous scattering in the diffraction data Most commonly, intensities of the acentric as well as non-acentric reflections are used in the following expression to calculate Δ:
Δ=<|I₍₊₎−I₍₋₎|/I> (I)
Since for the anomalous scattering signals I₍₊₎≈I₍₋₎, it follows from equation (I) that larger values of Δ correspond to stronger anomalous scattering signals. Equation (I) does not, however, account for noise inherently present in the diffraction data. Therefore, Δ provides a relatively insensitive index for evaluating the strength of anomalous scattering in an X-ray diffraction data set.

An important feature of the methods described above is the extraction of a weak anomalous scattering signal (for example, 1% or less of the overall intensity of the signal) from a set or sets of the diffraction data. Thus, an accurate measure of an anomalous scattering signal and noise level in the data is highly beneficial in this context. Specifically, the larger the value of Δ, the stronger the anomalous scattering signal in the data set. However, for Δ to be a sensitive indicator, one must also account for the noise (or error) level in the data.

Rsym is another indicator routinely used to judge the quality of the diffraction data set with the lower values of Rsym indicating better data quality. Rsym is defined by the expression:
Rsym =<Σ[|I−<I>|]/ΣI> (II)
wherein lower values of Rsym correspond to better data quality.

As indicated by equation II, Rsym measures only the agreement between symmetry related reflections. Because of this, Rsym again is not a reliable index for judging the noise level in the overall data set. For example, from counting statistics one would expect that increasing the redundancy of the data set would lower the measurement error of the merged data set. (It is common practice in data acquisition of protein crystals to collect a few batches of data either on different crystals or on different runs of the same crystal. All these data may be processed and merged to provide a whole data set during experimental error assessment, correction and scaling.) However, increasing the redundancy of the X-ray diffraction data set usually results in a slight increase in the Rsym value of the merged data set. Thus, an index that is closely related to the error level in the merged data set is greatly needed in the art. The need, therefore, exists to provide a quantitative and more accurate scheme for the evaluation of anomalous scattering signal and noise levels.

In a particular case of protein crystals belonging to a non-centrosymmetrical space group and containing heavy atoms contributing to anomalous dispersion, Friedel's law for certain classes of reflections is not satisfied. In other words, I₍₊₎≈₍₋₎ for certain classes of reflections in the presence of anomalous dispersion. However, a class of centrosymmetrical reflections always exists in the diffraction data set for all crystallographic space groups with the exception of groups 1 and 3. For such centrosymmetrical reflections I₍₊₎=I₍₋₎. Therefore, in a typical X-ray diffraction data set there will be centric (ΔI_{c}=I₍₊₎−I₍₋₎₌0) and acentric (ΔIₐ=I₍₊₎−I₍₋₎≈0) reflections.

As crystalline structures and their physical environment usually contains structural defects, ΔI_{c} for centrosymmetrical reflection will be a non-zero value attributed to the structural defects of the crystal and experimental errors. Macromolecular crystals contain a wide variety of defects, such as twinning, small molecular rotations, displacements, molecular structure variations from unit cell to unit cell, small-angle grain boundaries, cracks, handling damage, and crystal bending, inclusions, stacking faults and other short-range disorders. In addition, experimental errors also result in non-zero values of ΔI_{c}. Therefore, the non-zero value of ΔI_{c} can be used to sensitively evaluate the level of noise in a diffraction data set. Also, since in the presence of anomalous reflections ΔIₐ=I₍₊₎−I(−)≈0, ΔIₐ data contain both the anomalous scattering signal and noise. Equations III and IV illustrate this concept mathematically:
ΔIₐ=Signal+Noise (III)
ΔI_{c}=Noise (IV)

Knowledge of ΔIₐ and ΔI_{c}, as well as total reflection intensity I, allows the following two parameters to be obtained for acentric and centric reflections, respectively:
Δa=<|ΔIₐ|/σ_{I}> (V)
Δc=<|ΔI_{c}|/σ_{I}> (VI)
wherein σ_{I} is the standard deviation of the measured intensities. As the noise levels of the centric and acentric reflections are expected to be the same, Δc represents the measured noise level of the diffraction data in terms of an intensity difference. Further, the difference between Δa and Δc, (Δa−Δc), or, alternatively, \sqrt{(Δa)²−(Δc)²} provide an accurate and sensitive measurement of the anomalous scattering signal corrected for noise. Accordingly, one can define the following parameters, which are useful for evaluating the quality of an X-ray diffraction data set:
Δs=Δa−Δc (VIIa)
or
Δs=\sqrt{(Δa)²−(Δc)²} (VIIb)

$$Ras = \frac{Δ a}{Δ c} \qquad ( VIII )$$

$$Pas = \frac{Δ s}{〈 \frac{I}{{σ}_{I}} 〉} \qquad ( IX )$$

As shown in equations VIIa and VIIb, Δs is the anomalous scatting signal corrected for noise. Use of Δs as defined in equation VIIa or VIIb is determined by a number of factors including the crystal structure, extent of mosaicity and the intensity distribution of reflections. Ras is the ratio of the measured intensity differences for acentric and centric reflection pairs corresponding to anomalous scattering signal plus noise and noise, respectively, which provides a very accurate and sensitive index for evaluating signal-to-noise ratios corresponding to the anomalous scattering signal. In an exemplary embodiment, Ras is the measured anomalous scattering signal-to-noise ratio. Pas is an indication of the measured anomalous scattering power of the crystal.

The larger the value of Ras, the stronger the anomalous scattering signal, and Ras values less than one (Ras<1) indicate no anomalous scattering signal. The Ras statistical index may be used to quantitatively evaluate anomalous scattering signal and noise levels in X-ray diffraction experiments and provides a tool for evaluating the quality of diffraction systems including the X-ray source, detector and crystal alignment system. Ras is useful in monitoring the quality of the data in terms of data collection strategy, instrument settings, choice of data processing program and other factors. The Ras index can also be used during data collection to evaluate whether enough data has been collected to provide the needed anomalous scattering signal strength to solve the structure or whether additional data need to be collected.

In addition, Ras provides a statistical index which more accurately and more objectively evaluates the anomalous scattering signal and noise levels in X-ray diffraction data than Rsym, <I/σ_{I}>, Δa and other data evaluation schemes currently used by crystallographers. <I/σ_{I}> is not a signal-to-noise ratio in terms of anomalous scattering and is also subject to the procedure during integration.

Macroscopic crystals, especially protein crystals, are mosaics of submicroscopic arrays. As a result of this mosaicity, X-ray beams diffracted from a crystal propagate along a plurality of axes forming a cone of X-ray trajectories extending in space away from the crystal sample. Therefore, each reflection recorded by an X-ray detector actually comprises an intensity distribution in two spatial dimensions. The functionality of such an intensity distribution depends on crystal structure and may often be represented in terms of one or more a Gaussian functions, Lorentzian functions or combinations of these. The statistical analysis methods described above can be improved by taking into consideration the functional form of the intensity distribution of acentric and centric reflections. For example, for crystals exhibiting reflections having Gaussian intensity distribution, Δa and Δc are more accurately represented by the following expressions having a σ²_{I} term substituted into the denominator of equations V and VI:
Δa=<|ΔIₐ|/σ_{I}²> (X)
Δc=<|ΔI_{c}|/σ_{I}²> I(XI)
wherein σ²_{I} is the square of the standard deviation of the measured intensities. Therefore, the present invention includes alternative statistical treatments of acentric and centric reflection data, which depends on the functional form the observed intensity profiles.

The method described above works well under the assumption that the number of intensity measurements N(+) and N(−) are equal. In practice it happens that those numbers are not actually the same and where N(+) and N(−) can differ significantly, therefore making I(+) and I(−) statistically uneven during the data reduction process, introducing noise to the Bijvoet difference, which becomes significant at low redundancy. To correct such uneven measurements, the parameter corresponding to the measure of the evenness of the Bijvoet pair distribution is useful for characterizing anomalous scattering signal to nosie ratios:

$$Eas = 〈 \frac{min ( N ( + ) , N ( - ) )}{max ( N ( + ) , N ( - ) )} 〉 \qquad ( XII )$$

Eas also provides an accurate and sensitive index for evaluating signal-to-noise ratios of an X-ray diffraction data set.

In the absence of noise, rotational symmetry related reflections, such as 2-, 3-, 4-, and 6-fold symmetry reflection, are also predicted to have differences in intensity equal to zero. Therefore, differences of the intensities of these reflection pairs may also be used to directly measure noise levels in X-ray diffraction data. The use of rotational symmetry related reflections is especially beneficial in certain circumstances, such as when there is a lack of sufficient centric pairs in the data to allow for an accurate estimate of the noise levels using centric reflection data alone. However, in order to use this additional intensity data, the diffraction data set needs to be first processed in a Laue group with a lower degree of symmetry. The statistics are then taken before the data are merged into the correct Laue group.

The above-described method was implemented in 3DSCALE, which is a software package for experimental error correction using 3-dimensional error models with Free-R tests. In 3DSCALE, centric and acentric reflections are flagged but not differentiated during the experimental error corrections and scaling. The parameters proposed and described in the present method are evaluated as output statistics. In particular, during data collection the collected frames are integrated synchronously with the data collection error corrections. The scaling process is set up to be performed periodically to provide an on-the-fly evaluation and monitoring of the quality of data collected over a certain time period.

The above-described method was tested using the diffraction data of the Zn-free insulin crystal (space group I2_{I}3, a=78.95 Å). The data were collected up to the 2.15 Å resolution using a Bruker Proteum-R CCD detector mounted on a Rigaku RUH3R rotating anode generator using focused (MSC/Blue confocal optics) CuKα radiation. A total of 900, 0.2° oscillation images were recorded using an exposure time of 1 minute. The intensities were integrated with Bruker's new data analysis package PROTEUM. Data were scaled using modified 3DSCALE package in accordance with the method described above. Three data sets representing 60°, 120°, and 180° of crystal rotation were generated by scaling 300, 600, and 900 images, respectively. For each data set, Δa, Δc, Ras, Pas and Eas were calculated using 10 different resolution shells. The calculation results are presented in Tables 1a-1c below.

TABLE 1(a)
60° C. data set

| Reso. | | | | | | | |
|---|---|---|---|---|---|---|---|
| Shell(Å) | Rsym | <I/σ₁> | Δa | Δc | Ras | Pas | Eas |
| 4.78 | 0.0248 | 33.77 | 4.35 | 2.33 | 1.87 | 0.0598 | 0.931660 |
| 3.76 | 0.0235 | 33.70 | 3.68 | 2.16 | 1.70 | 0.0451 | 0.895819 |
| 3.28 | 0.0239 | 31.04 | 3.22 | 2.10 | 1.53 | 0.0361 | 0.873172 |
| 2.97 | 0.0244 | 28.48 | 2.88 | 2.01 | 1.43 | 0.0304 | 0.857861 |
| 2.75 | 0.0252 | 25.70 | 2.64 | 1.92 | 1.38 | 0.0280 | 0.848586 |
| 2.58 | 0.0260 | 23.54 | 2.44 | 1.83 | 1.33 | 0.0257 | 0.840851 |
| 2.45 | 0.0267 | 22.03 | 2.28 | 1.63 | 1.41 | 0.0299 | 0.855393 |
| 2.34 | 0.0271 | 21.04 | 2.16 | 1.62 | 1.33 | 0.0255 | 0.862493 |
| 2.24 | 0.0275 | 20.37 | 2.06 | 1.64 | 1.26 | 0.0207 | 0.865128 |
| 2.15 | 0.0276 | 19.97 | 1.99 | 1.63 | 1.22 | 0.0182 | 0.870441 |

TABLE 1(b)
120° C. data set

| Reso. | | | | | | | |
|---|---|---|---|---|---|---|---|
| Shell(Å) | Rsym | <I/σ₁> | Δa | Δc | Ras | Pas | Eas |
| 4.78 | 0.0285 | 30.21 | 5.44 | 2.07 | 2.63 | 0.01115 | 0.972757 |
| 3.77 | 0.0279 | 30.06 | 4.45 | 2.05 | 2.16 | 0.0796 | 0.950701 |
| 3.28 | 0.0282 | 27.84 | 3.89 | 1.96 | 1.98 | 0.0691 | 0.940222 |
| 2.97 | 0.0289 | 25.61 | 3.45 | 1.85 | 1.87 | 0.0627 | 0.931736 |
| 2.75 | 0.0297 | 23.25 | 3.13 | 1.76 | 1.77 | 0.0586 | 0.927408 |
| 2.58 | 0.0306 | 21.36 | 2.86 | 1.70 | 1.69 | 0.0546 | 0.922546 |
| 2.45 | 0.0314 | 19.95 | 2.68 | 1.62 | 1.65 | 0.0529 | 0.923495 |
| 2.34 | 0.0319 | 19.07 | 2.50 | 1.67 | 1.49 | 0.0431 | 0.915831 |
| 2.25 | 0.0322 | 18.44 | 2.35 | 1.66 | 1.42 | 0.0374 | 0.909613 |
| 2.15 | 0.0324 | 18.11 | 2.23 | 1.53 | 1.46 | 0.0387 | 0.909807 |

TABLE 1(c)
180° C. data set

| Reso. | | | | | | | |
|---|---|---|---|---|---|---|---|
| Shell(Å) | Rsym | <<I/σ₁> | Δa | Δc | Ras | Pas | Eas |
| 4.78 | 0.0295 | 25.44 | 5.70 | 1.66 | 3.43 | 0.01586 | 0.915457 |
| 3.76 | 0.0293 | 25.38 | 4.51 | 1.69 | 2.67 | 0.1111 | 0.892230 |
| 3.28 | 0.0300 | 23.77 | 3.89 | 1.68 | 2.32 | 0.0933 | 0.877214 |
| 2.97 | 0.0307 | 22.16 | 3.54 | 1.64 | 2.16 | 0.0858 | 0.866732 |
| 2.75 | 0.0316 | 20.37 | 3.26 | 1.62 | 2.01 | 0.0805 | 0.859751 |
| 2.58 | 0.0325 | 18.92 | 3.03 | 1.60 | 1.90 | 0.0759 | 0.853574 |
| 2.45 | 0.0333 | 17.81 | 2.89 | 1.58 | 1.83 | 0.0733 | 0.850606 |
| 2.34 | 0.0338 | 17.11 | 2.71 | 1.72 | 1.58 | 0.0579 | 0.838507 |
| 2.24 | 0.0342 | 16.59 | 2.56 | 1.76 | 1.45 | 0.0480 | 0.828263 |
| 2.15 | 0.0344 | 16.32 | 2.41 | 1.88 | 1.28 | 0.0323 | 0.821201 |

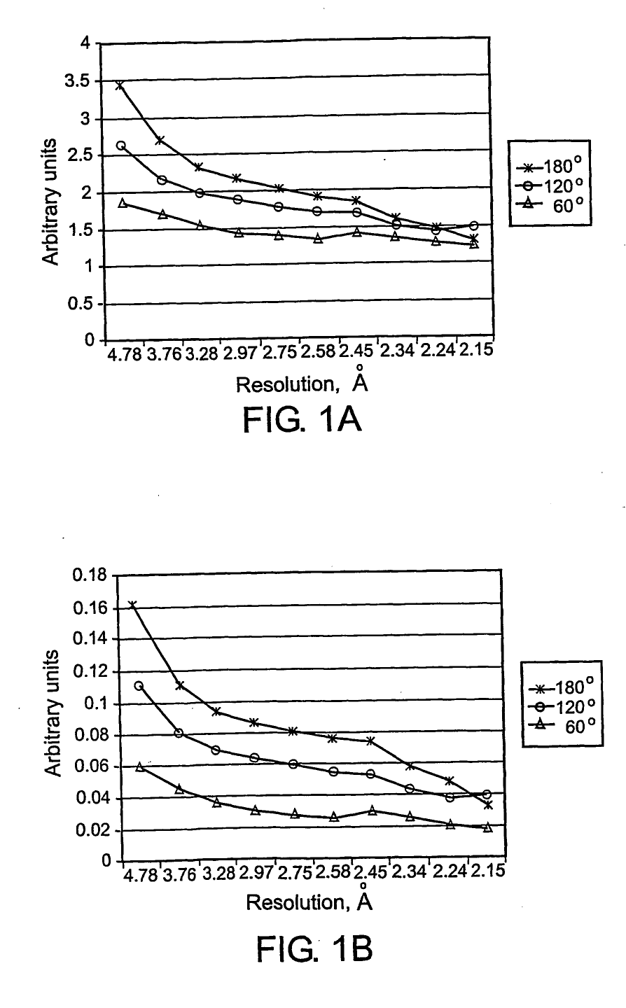

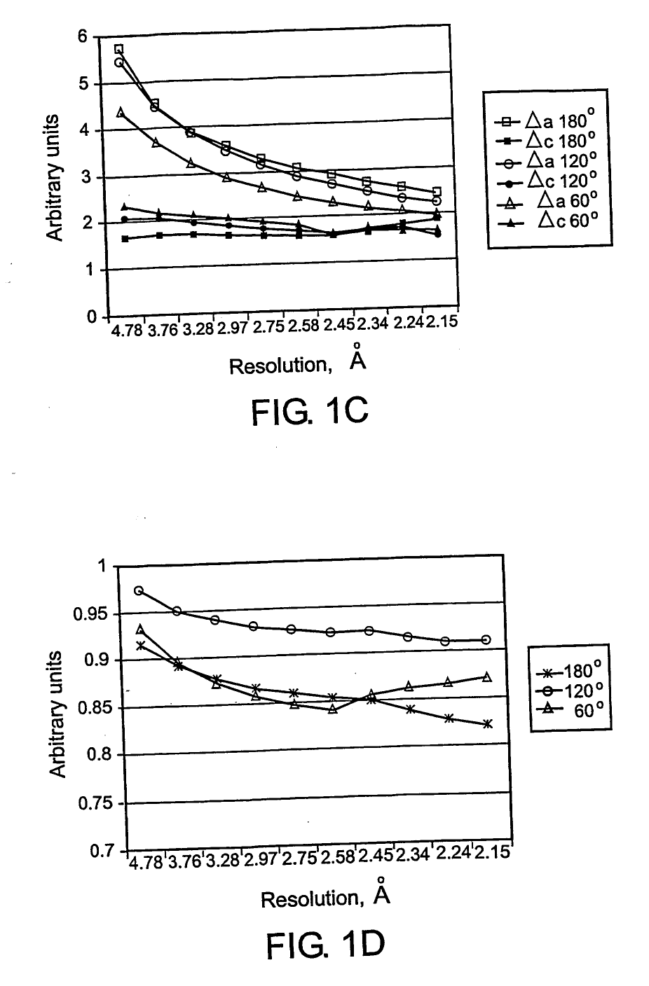

Turning now to FIG. 1, the triangles, circles and stars on the data lines correspond to the 60°, 120°, and 180° Zn-free insulin data sets, respectively. FIG. 1A illustrates the values of Ras versus resolution. It can be seen that all three data sets have the signal/noise ratio Ras> 1.0. Ras improves with increasing redundancy from 60° data set to 180° data set. FIG. 1B illustrates the values of Pas versus resolution. FIG. 1C illustrates the values of Δa and Δc versus resolution. Δc indicates the noise level in the data. FIG. 1D illustrates the values of Eas versus resolution, indicating that the Bijvoet pairs I₍₊₎ and I₍₋₎ are not evenly measured in the data. Eas of the 180° data set drops at high-resolutions shells counts for the decrease of the data quality compared with the 120° data set.

The Ras values provided in Table 1 and shown in FIG. 1A illustrate that all three data sets contain anomalous scattering signals that are clearly above the noise level. However, different resolution cutoffs must be used for successful phasing: 3.0 Å for the 60° data set and 2.2 Å for the 120° and 180° data sets, assuming a desired Ras value above 1.5. The Pas plot, shown in FIG. 1B, shows the measured anomalous scattering power in the data sets.

As shown in FIG. 1C, Δa is above 2.0 at the highest resolution. However, without the knowledge of Δc, which is significantly off from the theoretical 0.0 as shown in FIG. 1C, it is not possible to give a meaningful evaluation of the anomalous scattering signal. With the increasing redundancy, the anomalous scattering signal improves from the 60° data to the 180° data. It can be seen that beyond 2.5 Å the plots become erratic and the 180° data does not show much improvement compared with the 120° data. FIG. 1D shows that Eas is significantly off from ideal 0.0 for all sets. Eas of the 180° data is worse than that of the 120° C. data, which may introduce noise to the Bijvoet difference that cancels out the improvement due to the increase of redundancy. In fact, the whole data was collected by a single consecutive 180° ω scan, which is not optimized for collecting Bijvoet pairs.

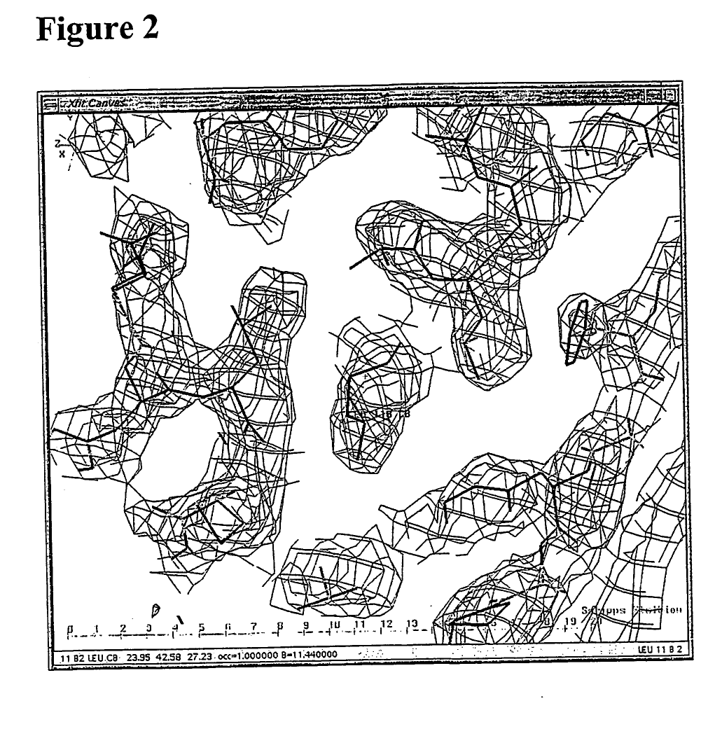

To calculate the electronic density map, the data for the substructure of sulfurs was solved by XM using the 60° data with 3.0 Å resolution cutoff that was suggested from the analysis of the Ras and Pas plots obtained in the experiments. We used the phases generated by SAS phasing by ISAS2001 to calculate the interpretable electron density map around Leu 11B of Zn-free insulin, as shown in FIG. 2. The map was calculated using the phases derived by ISAS2001 with the 60° data set to 3.0 Å. The 3.0 Å resolution cutoff was suggested by Ras plot.

All references cited in this application are incorporated in their entireties by reference herein to the extent that they are not inconsistent with the present disclosure in this application. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques specifically described herein are intended to be encompassed by this invention.

We claim:

1. A method of diffractometrically resolving a structure of a crystal by obtaining an electron density distribution of the crystal, the method comprising:
obtaining X-ray diffraction data reduced to intensities corresponding to centric and acentric reflections;
using the intensities corresponding to the centric reflections to estimate a noise level of the X-ray diffraction data;
using the intensities corresponding to the acentric reflections to obtain an observed anomalous signal of the X-ray diffraction data;
calculating an anomalous scattering signal corrected for noise;
calculating a ratio of said anomalous scattering signal corrected for noise to said noise level; and
calculating an anomalous scattering power of the crystal;
wherein said anomalous scattering signal corrected for noise is used to calculate the electron density distribution and to resolve said structure of said crystal.

2. A method of determining an electron density distribution of a crystal, said method comprising the steps of:
collecting X-ray diffraction data comprising intensities corresponding to a centric reflection pair and an acentric reflection pair;
subtracting the intensities of said centric reflection pair to obtain a first intensity difference;
subtracting the intensities of said acentric reflection pair to obtain a second intensity difference;
calculating an anomalous scattering signal corrected for noise using said first intensity difference and said second intensity difference; and
using said anomalous scattering signal corrected for said noise to determine an electron density distribution for the crystal.

3. The method of claims 2 wherein said first intensity difference is a measurement of the noise level in the X-ray diffraction data.

4. The method of claims 2 wherein said second intensity difference is a measurement of the anomalous scattering signal plus noise level in the X-ray diffraction data.

5. A method of determining an electron density distribution of a crystal, said method comprising the steps of:
collecting X-ray diffraction data comprising intensities corresponding to a plurality of centric reflection pairs and a plurality of acentric reflection pairs;
subtracting the intensities of said plurality of centric reflection pairs to obtain a plurality of first intensity differences and calculating an average first intensity difference;
subtracting the intensities of said plurality of acentric reflection pairs to obtain a plurality of second intensity differences and calculating an average second intensity difference;
calculating an anomalous scattering signal corrected for noise using said average first intensity difference and said average second intensity difference; and
using said anomalous scattering signal corrected for said noise to determine an electron density distribution for the crystal.

6. The method of claims 5 wherein said average first intensity difference is a measurement of the noise level in the X-ray diffraction data.

7. The method of claims 5 wherein said average second intensity difference is a measurement of the anomalous scattering signal plus noise level in the X-ray diffraction data.

8. The method of claim 5 further comprising the step of calculating a first weighted average of the first intensity difference by dividing said average first intensity difference by the standard deviation of said intensities and calculating a second weighted average of the second intensity difference by dividing said average second intensity difference by the standard deviation of said intensities.

9. The method of claim 5 further comprising the step of calculating a ratio of said first weighted average of the first intensity difference and said second weighted average of the second intensity difference.

10. The method of claim 9 further comprising the step of calculating a first weighted average of the first intensity difference by dividing said average first intensity difference by the square of the standard deviation of said intensities and calculating a second weighted average of the second intensity difference by dividing said average second intensity difference by the square of the standard deviation of said intensities.

11. The method of claim 10 further comprising the step of calculating a ratio of said first weighted average of the first intensity difference and said second weighted average of the second intensity difference.

12. The method of claims 2 or 5 further comprising the step of using said anomalous scattering signal corrected for said noise to determine an anomalous scattering power of said crystal.

13. The method of claims 1, 2 or 5 wherein the crystal comprises a material selected from the group comprising: a protein; a peptide; a protein-protein complex; a protein-lipid complex; an olignucleotide; a carbohydrate; a lipid-carbohydrate complex and a nucleic acid-protein complex.

14. A method of monitoring changes in the signal-to-noise ratio of X-ray diffraction data, said method comprising the steps of:
measuring a first set of intensities corresponding to a plurality of centric reflection pairs and a plurality of acentric reflection pairs and calculating an first anomalous scattering signal-to-noise ratio for said first set of intensities;
measuring a second set of intensities corresponding to a plurality of centric reflection pairs and a plurality of acentric reflection pairs and calculating a second anomalous scattering signal to noise ratio for said second set of intensities; and
comparing said first anomalous scattering signal-to-noise ratio to said second anomalous signal-to-noise ratio.

15. The method of claim 14 wherein said first and second anomalous scattering signal-to-noise ratios are governed by the expression:
$$Ras = \frac{Δ a}{Δ c}$$
wherein Ras is the anomalous scattering signal-to-noise ratio, Δc is the ratio of the average intensity difference for said centric reflection pairs to the standard deviation of said intensities and Δa is the ratio of the average intensity difference for said acentric reflection pairs to the standard deviation of said intensities.

16. The method of claim 14 wherein said first and second anomalous scattering signal-to-noise ratios are governed by the expression:
$$Ras = \frac{Δ a}{Δ c}$$
wherein Ras is the anomalous scattering signal-to-noise ratio, Δc is the ratio of the average intensity difference for said centric reflection pairs to the square of the standard deviation of said intensities and Δa is the ratio of the average intensity difference for said acentric reflection pairs to the square of the standard deviation of said intensities.

17. A method of collecting X-ray diffraction data, said method comprising the steps of:
measuring intensities corresponding to a plurality of centric reflection pairs and a plurality of acentric reflection pairs;
calculating anomalous scattering signal-to-noise ratios for said intensities corresponding to a plurality of data collection time intervals; and
stopping the collection of said intensities when said anomalous scattering signal-to-noise is below an anomalous scattering signal-to-noise threshold.

18. The method of claim 17 wherein said anomalous scattering signal-to-noise threshold is 1.67.

19. A method of increasing the anomalous scattering signal-to-noise ratio of X-ray diffraction data, said method comprising the steps of:
dividing said X-ray diffraction data into a plurality of discrete sub-groups corresponding to different collection time intervals;
calculating the anomalous scattering signal-to-noise ratio of each of said discrete sub-groups; and
combining two or more merged subgroups, thereby generating a combined X-ray diffraction data set having an anomalous scattering signal-to-noise ratio greater than the anomalous scattering signal-to-noise ratios of said merged subgroups.
